(19) United States
(12) Patent Application Publication
(10) Pub. No.: US 2010/0221602 A1
(43) Pub. Date: Sep. 2, 2010

(54) METHOD FOR MANUFACTURING SEALED BATTERY AND SEALED BATTERY

(75) Inventors: Yusuke Itou, Itano-gun (JP); Kenji Nansaka, Osaka (JP); Yasuhiro Yamauchi, Sumoto-shi (JP); Toshiyuki Nohma, Kobe-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/713,993

(22) Filed: Feb. 26, 2010

(30) Foreign Application Priority Data
Mar. 2, 2009 (JP) 2009-047609

(51) Int. Cl. H01M 2/08; H01M 4/82

(52) U.S. Cl. 429/185; 29/623.1; 29/623.4

(57) ABSTRACT

A method for manufacturing a sealed battery 10 includes a step of bringing into contact a collector 18 and collector receiving part 25 having hemispherical protrusions 18a and 25a, respectively, with both sides of at least one of the plurality of positive electrode substrate exposed portions 14 and the plurality of negative electrode substrate exposed portions 15 so that the collector 18 and collector receiving part 25 oppose each other, where the displacement between central axes of the hemispherical protrusions 18a and 25a is not more than ½ of the diameter of the hemispherical protrusions 18a and 25a, and a step of resistance-welding between the collector 18 and collector receiving part 25 by applying current under a pressure. According to the method, the collector and collector receiving part can be reliably resistance-welded to the substrates.

### TECHNICAL FIELD

The present invention relates to a sealed battery and a method for manufacturing a sealed battery. In particular, the invention relates to a method for manufacturing a sealed battery which, in an electrode assembly including a plurality of positive electrode substrate exposed portions at one end and a plurality of negative electrode substrate exposed portions at the other end, when a collector and collector receiving part each having a hemispherical protrusion (projection) are resistance-welded so as to interpose at least one of the plurality of substrates, is substantially free from welding defects, allowing manufacture of a reliable sealed battery. Further, the invention relates to a sealed battery manufactured by such method.

### BACKGROUND ART

Exhaust controls of carbon dioxide gas and the like are being tightened up in view of the recent moves to protect the environment. In the car industry, not only automobiles using fossil fuels such as gasoline, diesel oil and natural gas, but also electric vehicles (EVs) and hybrid electric vehicles (HEVs) have been developed actively. In addition, a recent sudden rise in the prices of the fossil fuels has accelerated the development of EVs and HEVs.

For batteries for such EVs and HEVs, nickel-hydrogen secondary batteries and lithium ion secondary batteries are generally used. Such batteries have been required to achieve a highly developed traveling performance as a basic automobile performance as well as taking environmental concerns into consideration. Thus, not only simply increasing a battery capacity but also increasing a battery output power in order to significantly affect acceleration performance or hill climbing performance of the automobiles is needed. However, when a battery is discharged at high power, a high current is applied in the battery, and whereby, the contact resistance between a substrate and a collector as the electric power generating elements generates a great deal of exothermic heat. Therefore, because not only do the batteries for EVs and HEVs need to have a large size and a large capacity, but also need to be capable of supplying a high current in order to prevent electric power loss in the batteries and to reduce the exothermic heat, various improvements have been made on reducing the internal resistance by preventing welding defects between the substrate and collector as the electric power generating elements.

Examples of the method for electrically joining the substrate and collector as the electric power generating elements include mechanical crimping and welding. Among them, fusion welding is suitable for the joining method of the batteries requiring high power. Furthermore, for the material of the negative electrode assembly in the lithium ion secondary batteries, copper or copper alloy is used in order to reduce the electrical resistance. However, the welding of such materials needs a very large amount of energy because the copper or copper alloy has the characteristics of low electric resistance and high thermal conductivity.

As the method for welding between the substrate and collector as the electric power generating elements, the following related art methods are known:

(1) laser welding method (see JP-A-2001-160387);

(2) ultrasonic welding method (see JP-A-2003-197174 and JP-A-2002-008708); and

(3) resistance welding method (see JP-A-2006-310254 and JP-UM-A-59-098571).

In the laser welding method, a high-energy laser beam is required because the copper or copper alloy to be welded has a high reflectivity of about 90% with respect to the yttrium-aluminum-garnet (YAG) laser beam that is widely used to weld metals. Furthermore, the laser welding of the copper or copper alloy has problems that the weldability greatly varies depending on the surface condition, and that spattering is unavoidable in the same manner as in the laser welding of other materials.

Furthermore, the ultrasonic welding also has problems that a large amount of energy is required because the copper or copper alloy to be welded has high thermal conductivity, as well as that the active material particles falls off by the ultrasonic vibration during welding. Moreover, the resistance welding has problems that high current is needed to be input in a short period because the copper or copper alloy to be welded has low electric resistance and high thermal conductivity, that fusion welding of the electrode rod and the collector may occur during welding, and that melting or spark generation occurs at other than the welded parts.

As mentioned above, the three welding methods have their advantages and disadvantages. From the viewpoints of productivity and economy, the resistance welding method which has long been used as a method for welding between metals is preferably employed. However, in particular, in the electrode assembly of the sealed battery for EVs and HEVs having a plurality of positive electrode substrate exposed portions at one end and a plurality of negative electrode substrate exposed portions at the other end (see JP-A-2006-310254), when the collector and collector receiving part made of copper are resistance-welded with respect to the substrates made of copper or copper alloy, a great deal of welding energy is necessary for firmly welding because of a large number of the substrates between the collector and collector receiving part.

In contrast, for the resistance welding, in order to concentrate the welding current to reduce reactive current, an almost hemispherical protrusion referred to as projection is formed on the member to be welded. The collector and collector receiving part having such hemispherical protrusions are placed opposing each other so as to have the same central axis of each protrusion and so as to interpose the plurality of substrates, and then between the collector and collector receiving part is resistance-welded under a pressure.

However, such resistance welding has the problem that, because the plurality of substrates are only laminated with each other, when the pressure is applied to the collector and collector receiving part, the positions of the protrusions formed on the collector and collector receiving part are dislocated and the plurality of substrates are partly dislocated, and consequently, the welding cannot be stably carried out. This phenomenon will be explained with reference to FIG. 4. Here, FIG. 4A is a schematic partial sectional view showing the electrode assembly and electrode arrangement of welding equipment before welding, and FIG. 4B is a schematic partial sectional view of the dislocated welded part by pressure.

An electrode assembly 50 has, at one end, a plurality of positive electrode substrate exposed portions 51 that are gathered and, at the other end, a plurality of negative electrode substrate exposed portions 51 that are gathered. FIG. 4A shows one of the substrate exposed portions. A hemispherical protrusion 53 of a collector 52 contacts with a bottom surface of the substrate exposed portions 51, further, a protrusion 55 of a collector receiving part 54 contacts with a top surface of the substrate exposed portions 51, and both of the hemispherical protrusions 53 and 55 are placed so as to have the same central axis C. Then, copper electrode rods 56 and 57 of resistance welding equipment (not shown in the drawings) are brought into contact with the collector 52 and collector receiving part 54 from above and below so as to interpose them. FIG. 4A shows the state at this time.

Then, both of the electrode rods 56 and 57 are pressed against each other to be slightly short-circuited, and an experimentally predetermined optimum welding current (for example, a peak current of 15 kA) is applied between both electrode rods 56 and 57 for a short period to carry out resistance welding. In this process, if the central axes C of both hemispherical protrusions 53 and 55 are not displaced when both of the electrode rods 56 and 57 are pressed against each other, reactive current that is not used for welding is reduced to generate a fine weld bead (weld mark), and then the collector 52 and collector receiving part 54 are firmly welded to the substrate exposed portions 51.

However, in the case that the placement of the collector 52, collector receiving part 54, and both electrode rods 56 and 57 is optimized to such condition without displacement at the time of resistance welding, if the central axes of both the hemispherical protrusions 53 and 55 are only slightly displaced, the central axes of both the hemispherical protrusions 53 and 55 may be further displaced, or at least one of the collector 52 and collector receiving part 54 may tilt, when both the electrode rods 56 and 57 are pressed against each other, as shown in FIG. 4B. When the resistance welding is carried out in this condition, the welding current is not concentrated to the hemispherical protrusions to sometimes generate welding defects, or a contact area between the welding electrode rod 56 or 57 and the collector 52 or collector receiving part 54 is reduced to sometimes cause explosive ignition.

### SUMMARY

An advantage of some aspects of the present invention is to provide a method for manufacturing a sealed battery, in which, when a collector and collector receiving part each having a hemispherical protrusion are resistance-welded with respect to a plurality of substrate exposed portions that are gathered, the collector and collector receiving part are inhibited to tilt and a sealed battery with high reliability can be manufactured, and to provide a sealed battery manufactured by the method thereof.

JP-UM-A-59-098571 shows the example in which, when a pair of electrode plate edges is integrally spot-welded to a plain part of the electrode plate, projections are formed on surfaces of the pair of electrode plate edges to have concave-convex shapes that are engaged to the electrode plate and the projections do not oppose each other. However, there is no description of the hemispherical projection and the problems when such hemispherical projections are used.

According to a first aspect of the present invention, a method for manufacturing a sealed battery includes the following steps of (1) to (3): (1) an electrode assembly for a sealed battery including a plurality of positive electrode substrate exposed portions at one end and a plurality of negative electrode substrate exposed portions at the other end is formed; (2) a collector and collector receiving part each having a hemispherical protrusion are brought into contact with both sides of at least one of the plurality of positive electrode substrate exposed portions and the plurality of negative electrode substrate exposed portions, in which the collector and collector receiving part oppose each other and, when a displacement between central axes of the hemispherical protrusions is L and when a base diameter of the hemispherical protrusion is W, the relation of 0<L≦W/2 is satisfied; and (3) between the collector and collector receiving part is resistance⁻welded by applying current under a pressure.

The electrode assembly for a sealed battery including the plurality of positive electrode substrate exposed portions at one end and the plurality of negative electrode substrate exposed portions at the other end is used for EVs and HEVs that require high current charging and discharging. In addition, the method for manufacturing the sealed battery according to the aspect of the invention includes the step in which, when the collector and collector receiving part each having a hemispherical protrusion are welded to both sides of at least one of the plurality of positive electrode substrate exposed portions and the plurality of negative electrode substrate exposed portions, the collector and collector receiving part are brought into contact so as to oppose each other and so as to satisfy the relation of 0<L≦W/2 when the displacement between the central axes of both the hemispherical protrusions is L and when the base diameter of the hemispherical protrusion is W. Here, the hemispherical protrusion is generally referred to as “projection”, and widely used for reducing reactive current by the concentration of welding current during resistance welding.

If the central axes of the hemispherical protrusions of the collector and collector receiving part has absolutely no displacement, by rights, the resistance welding could be best carried out. However, in the actual manufacturing process of the sealed battery, even when the condition is optimized to no displacement (L=0 mm), it is difficult to make absolutely no displacement condition because welding is carried out interposing the positive electrode substrate exposed portions or negative electrode substrate exposed portions made form multi-layered foil, and because such multi-layered positive electrode substrate exposed portions or negative electrode substrate exposed portions are pressed with electrode rods.

In contrast, according to the method for manufacturing the sealed battery according to the aspect of the invention, because the placement of the collector, collector receiving part and pair of electrode rods for resistance welding during resistance welding is placed so that the displacement L between the respective central axes of the hemispherical protrusions of the collector and collector receiving part satisfies the relation of 0<L≦W/2 with respect to the base diameter W of the hemispherical protrusion, the collector and collector receiving part are inhibited to tilt when the pair of resistance-welding electrode rods is pressed against each other. Thus, according to the method for manufacturing the sealed battery according to the aspect of the invention, the welding defects hardly occur because current is concentrated to the hemispherical protrusions, and moreover, the explosive ignition is inhibited because a contact area between the welding electrode rods and the collector or collector receiving part is hardly varied. Consequently, the sealed battery having the welded part with high reliability can be obtained.

When the displacement between the central axes of the hemispherical protrusions of the collector and collector receiving part is too large, the welding current is not concentrated to the hemispherical protrusions, so that the reactive current becomes large not to obtain a good weld mark. Furthermore, when the displacement is too small, the central axes are further displaced as mentioned above or at least one of the collector and collector receiving part tilts, so that the welded part with stable quality cannot be obtained. The displacement L between the respective central axes of hemispherical protrusions of the collector and collector receiving part is preferably W/10≦L≦W/2 with respect to the base diameter W of the hemispherical protrusion, and more preferably W/3≦L≦W/2.

The number of the protrusions formed on the collector and collector receiving part may be one or more in accordance with the size of the collector, and may be properly selected depending on resistance welding position required. One to five protrusions are formed on the collector corresponding to the number of the welding positions, one protrusion is formed on the collector receiving part, and one to five pieces of the collector receiving part may be used corresponding to the number of the welding positions. In addition, the base diameter W is preferably about W=1 to 5 mm, and more preferably W=2 to 4 mm.

Furthermore, the method for manufacturing the sealed battery according to the aspect of the invention can be applied to the substrate, collector and collector receiving part made of the same metal and those made of different metals, and equally applied to the positive electrode substrate and negative electrode substrate. Furthermore, the method for manufacturing the sealed battery according to the aspect of the invention can be applied to both rolled electrode assemblies and laminated electrode assemblies when the battery includes the electrode assembly for sealed batteries which has the positive electrode substrates exposed at one end and the negative electrode substrates exposed at the other end, and includes the collector and collector receiving part that are placed opposing each other with at least one of the substrates interposed therebetween, and further applied to both nonaqueous electrolyte secondary batteries and aqueous electrolyte secondary batteries.

Moreover, in the method for manufacturing the sealed battery according to the aspect of the invention, it is preferable that, in the step (2), a circular tape made of hot-melt adhesive resin or insulating tape with glue is placed around each of the hemispherical protrusions.

In order to reliably resistance-weld the plurality of positive electrode substrates having the positive electrode substrate exposed portions at one end and the plurality of negative electrode substrates having the negative electrode substrate exposed portions at the other end, a great deal of welding energy is required. In addition, when the welding energy is rendered large for resistance welding, the generation of spattered particles is increased, and the spattered particles move into the inside of the electrode assembly, so that the possibility of an inner short circuit due to the particles is increased. In the method for manufacturing the sealed battery according to the aspect of the invention, in the step (2), the circular tape made of hot-melt adhesive resin or insulating tape with glue is placed around each of the hemispherical protrusions, so that the spattered particles are caught in the circular tape made of hot-melt adhesive resin or insulating tape with glue not to be dispersed to the exterior. Thus, the method for manufacturing the sealed battery according to the aspect of the invention provides the advantage that the sealed battery whose welded part has higher reliability can be obtained as well as the advantage that a sealed battery with high reliability in which an inner short circuit seldom occurs can be obtained.

The hot-melt adhesive resin preferably has an adhesive temperature of about 70 to 150° C. and a melting temperature of 200° C. or higher, and further has the chemical resistance against an electrolyte and the like. Examples of the hot-melt adhesive resin for use include a rubber seal material, acid modified polypropylene and polyolefin hot-melt adhesive resin. Furthermore, examples of the insulating tape with glue for use include a polyimide tape, polypropylene tape and polyphenylene sulfide tape, and the tape may be a multi-layered tape having an insulating hot-melt adhesive resin layer.

Furthermore, the method for manufacturing the sealed battery according to the aspect of the invention may be applied to the plurality of substrates, collector and collector receiving part made of copper, copper alloy, aluminum or aluminum alloy.

The copper, copper alloy, aluminum or aluminum alloy has a lower electric resistance and higher thermal conductivity among commonly used electrically-conductive metals, so that high current is required during resistance welding. Thus, when the invention is applied to the plurality of substrates, collector and collector receiving part made of copper, copper alloy, aluminum or aluminum alloy, the invention can provide a significant advantage.

Furthermore, according to a second aspect of the invention, a sealed battery includes an electrode assembly having a plurality of positive electrode substrates exposed at one end and a plurality of negative electrode substrates exposed at the other end, and a collector and collector receiving part that are resistance-welded to at least one of the plurality of substrates interposed therebetween. In the sealed battery, a resistance weld mark is formed at an angle in the plurality of substrates between the collector and collector receiving part.

Furthermore, in the sealed battery according to the aspect of the invention, it is preferable that a tape made of hot-melt adhesive resin or insulating tape with glue is placed around each of the resistance⁻welded parts between the substrate and the collector and between the substrate and the collector receiving part. Moreover, it is preferable that the plurality of substrates, collector and collector receiving part are made of copper, copper alloy, aluminum or aluminum alloy.

The sealed battery in which the plurality of substrates between the collector and collector receiving part have the resistance weld mark at an angle can be manufactured according to the method for manufacturing the sealed battery according to the aspect of the invention described above. Thus, with the sealed battery according to the aspect of the invention, as fully described in the method for manufacturing the sealed battery according to the aspect of the invention, the central axes of the hemispherical protrusions of the collector and collector receiving part are optimized to be displaced, whereby the collector and collector receiving part are inhibited to tilt during resistance welding, and consequently, the sealed battery has few welding defects and welded parts with high reliability.

### BRIEF DESCRIPTION OF THE DRAWINGS

The invention will be described with reference to the accompanying drawings, wherein like numbers reference like elements.

FIG. 1A is an elevation view showing the internal structure of a prismatic nonaqueous electrolyte secondary battery as the sealed battery common to Examples and Comparative Examples, and FIG. 1B is a sectional view taken along the line IB-IB in FIG. 1A.

FIG. 2A is a schematic sectional view showing the electrode assembly and electrode arrangement of welding equipment of Examples 1 and 2 before welding, and FIG. 2B is a schematic sectional view of the welded part after welding.

FIG. 3A is a schematic sectional view showing the electrode assembly and electrode arrangement of welding equipment of Example 3 before welding, and FIG. 3B is a schematic sectional view of the welded part after welding.

FIG. 4A is a schematic partial sectional view showing the electrode assembly and electrode arrangement of welding equipment of the related art before welding, and FIG. 4B is a schematic partial sectional view of the dislocated welded part by a pressure.

### DESCRIPTION OF EXEMPLARY EMBODIMENTS

Hereinafter, the method for manufacturing the sealed battery according to an embodiment of the invention will be described with reference to each example and comparative example as well as drawings. However, each example described below is an illustrative example of the method for manufacturing a prismatic nonaqueous electrolyte secondary battery as the sealed battery for embodying the technical spirit of the invention, is not intended to limit the invention to the method for manufacturing the prismatic nonaqueous electrolyte secondary battery, and may be equally applied to other embodiments within the scope of the appended claims.

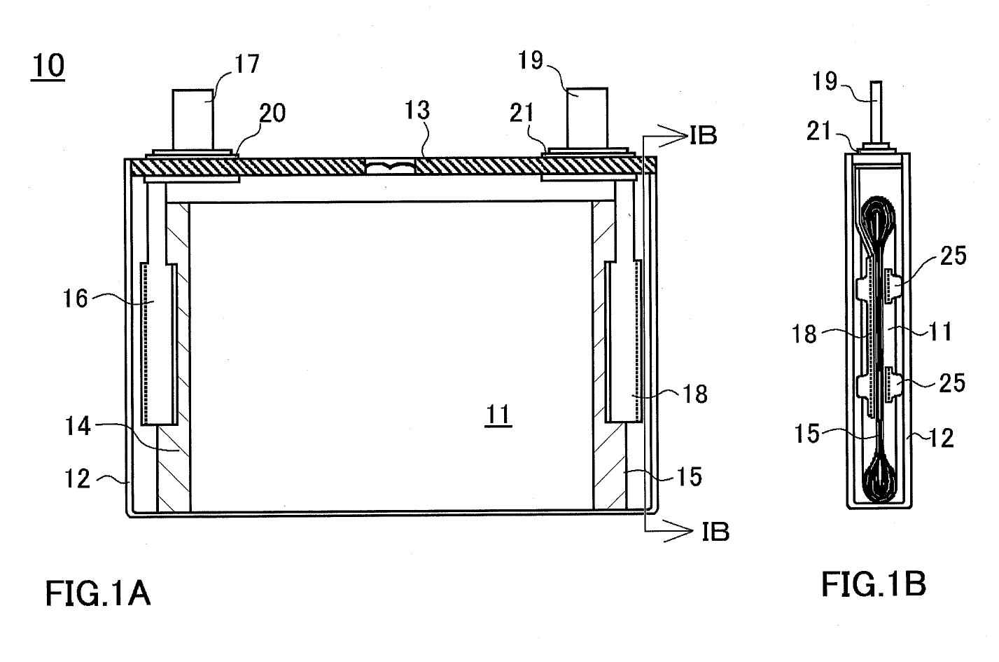

First, a prismatic nonaqueous electrolyte secondary battery as the sealed battery common to each Example and Comparative Example will be described with reference to FIG. 1A and FIG. 1B. A prismatic nonaqueous electrolyte secondary battery 10 was manufactured in the following way: a flat rolled electrode assembly 11 formed by rolling a positive electrode plate and negative electrode plate with a separator interposed therebetween (not shown in the drawings) was put into a prismatic battery outer can 12; and the battery outer can 12 was sealed with a sealing plate 13. The flat rolled electrode assembly 11 had, at one end in the rolling axis direction, positive electrode substrate exposed portions 14 where a positive electrode binder was not applied, and at the other end, negative electrode substrate exposed portions 15 where a negative electrode binder was not applied. The positive electrode substrate exposed portions 14 were connected to a positive electrode terminal 17 through a positive electrode collector 16, and the negative electrode substrate exposed portions 15 were connected to a negative electrode terminal 19 through a negative electrode collector 18. The positive electrode terminal 17 and negative electrode terminal 19 were joined by crimping to the sealing plate 13 through insulating members 20 and 21 composed of an insulating plate, gasket and the like, respectively.

To manufacture the prismatic nonaqueous electrolyte secondary battery, the flat rolled electrode assembly 11 was inserted into the battery outer can 12, then the sealing plate 13 was laser-welded to a mouth portion of the battery outer can 12, after that a nonaqueous electrolyte was poured from an electrolyte pour hole (not shown in the drawings), and then the electrolyte pour hole was sealed up. For the electrolyte, for example, in a mixed solvent of ethylene carbonate and diethyl carbonate having a volume ratio of 3:7, LiPF₆ was dissolved so as to have 1 mol/L to prepare the nonaqueous electrolyte to be used.

Next, the specific method for producing the flat rolled electrode assembly 11 common to each Example and Comparative Example will be described.

Manufacture of Positive Electrode Plate

The positive electrode plate was manufactured in the following manner. First, 94% by mass of lithium cobalt oxide (LiCoO₂) powder as the positive electrode active material, 3% by mass of carbon powder such as acetylene black or graphite as the conductive material, and 3% by mass of a binding agent composed of polyvinylidene fluoride (PVdF) were mixed, then, to the obtained mixture, an organic solvent composed of N-methyl-2-pyrrolidone (NMP) was added, and the whole was kneaded to prepare positive electrode active material mixture slurry. Next, a positive electrode substrate made of aluminum foil having a thickness of 20 μm was prepared, and the positive electrode active material mixture slurry prepared above was homogeneously applied on both sides of the positive electrode substrate to form positive electrode active material mixture layers. In this process, the application was carried out so as to form a positive electrode substrate exposed portion having a predetermined width (9 mm in this example), where the positive electrode active material mixture slurry was not applied, on the end part of one side in the width direction of the positive electrode substrate. Then, the positive electrode substrate with the positive electrode active material mixture layers was passed through a dryer, and NMP which is needed for preparing the slurry was dried to be removed. After drying, the positive electrode substrate with the positive electrode active material mixture layers was compressed with a roll press until the thickness became 0.06 mm to manufacture a positive electrode plate. The positive electrode plate manufactured in this manner was cut out into a strip shape having a width of 55.5 mm to obtain a positive electrode plate having, on one end part in the width direction, the strip-shaped positive electrode substrate exposed portion made of aluminum having a width of 9 mm.

Manufacture of Negative Electrode Plate

The negative electrode plate was manufactured in the following manner. First, 98% by mass of natural graphite powder as the negative electrode active material, and 1% by mass of carboxymethyl cellulose (CMC) and 1% by mass of styrene-butadiene rubber (SBR) as the binding agents were mixed, then, water was added, and the whole was kneaded to prepare negative electrode active material mixture slurry. Next, a negative electrode substrate made of copper foil having a thickness of 12 μm was prepared, and the negative electrode active material mixture slurry prepared above was homogeneously applied on both sides of the negative electrode substrate to form negative electrode active material mixture layers. In this case, the application was carried out so as to form a negative electrode substrate exposed portion having a predetermined width (9 mm in this example), where the negative electrode active material mixture slurry was not applied, on the end part of one side in the width direction of the negative electrode active material mixture layer. Then, the negative electrode substrate with the negative electrode active material mixture layers was passed through a dryer to be dried. After drying, the negative electrode substrate with the negative electrode active material mixture layers was compressed with a roll press until the thickness became 0.05 mm to manufacture a negative electrode plate. The negative electrode plate manufactured in this manner was cut out into a strip shape having a width of 55.5 mm to obtain a negative electrode plate having, on one end part in the width direction, the strip-shaped negative electrode substrate exposed portion made of copper foil having a width of 9 mm.

Manufacture of Rolled Electrode Assembly

The positive electrode substrate exposed portion of the positive electrode plate and the negative electrode substrate exposed portion of the negative electrode plate obtained above were displaced so as not to overlap each of the opposed electrode active material mixture layers, and then the electrode plates were rolled with a porous polyethylene separator having a thickness of 0.22 mm interposed therebetween to manufacture the flat rolled electrode assembly 11 that had a plurality of the positive electrode substrate exposed portions 14 made of aluminum foil at one end and a plurality of the negative electrode substrate exposed portions 15 made of copper foil at the other end, and the obtained flat rolled electrode assembly 11 was used in each Example.

Resistance Welding of Collector

For the flat rolled electrode assembly 11 of each Example and Comparative Example manufactured in this manner, the positive electrode collector 16 and a positive electrode collector receiving part (not shown in the drawings) made of aluminum were attached to the positive electrode substrate exposed portions 14 by resistance welding, and likewise, the negative electrode collector 18 and a negative electrode collector receiving part 25 made of copper were attached to the negative electrode substrate exposed portions 15 by resistance welding. The following description is in the case that the negative electrode collector 18 and negative electrode collector receiving part 25 made of copper were attached by resistance welding to the negative electrode substrate exposed portions 15.

### Examples 1 and 2 and Comparative Examples 1 and 2

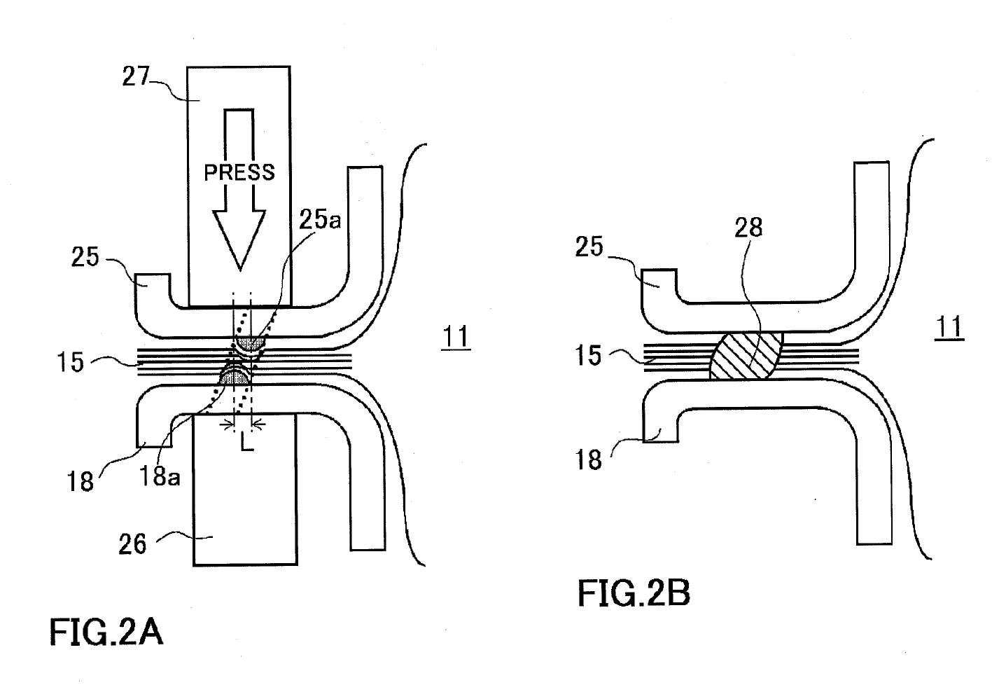

In the prismatic nonaqueous electrolyte secondary battery 10, the negative electrode collector 18 to be used was made of copper and had at the central part a protrusion serving as a projection (a height of 1.0 mm, a base diameter W=3.0 mm) 18a (see FIG. 2A), and the negative electrode collector receiving part 25 to be used was made of copper and had at the central part a protrusion serving as a projection (a height of 1.0 mm, a base diameter W=3.0 mm) 25a. First, the negative electrode substrate exposed portions 15 made of copper were gathered, then the negative electrode collector 18 made of copper was placed beneath the exposed portions so as to face the top of the protrusion 18a, and likewise, the negative electrode collector receiving part 25 was placed on the upper side of the exposed portions so as to face the top of the protrusion 25a. Here, the number of more than one such protrusion 18a of the negative electrode collector 18 was two, and two pieces of the negative electrode collector receiving part 25 having one protrusion 25a were used. As for the resistance welding, copper electrode rods 26 and 27 of resistance welding equipment (not shown in the drawings) were brought into contact with the negative electrode collector 18 and negative electrode collector receiving part 25 from above and below so as to interpose, the electrode rods 26 and 27 were pressed against each other to be slightly short-circuited, and an experimentally determined optimum welding current (a peak current of 15 kA) was applied between both of the electrode rods 26 and 27 for a short period to carry out the resistance welding.

During the resistance welding, the displacement L between the central axis of the protrusion 18a of the negative electrode collector 18 and the central axis of the protrusion 25a of the negative electrode collector receiving part 25 was varied to 0 mm (Comparative Example 1), 1.0 mm (Example 1), 1.5 mm (Example 2) and 2 mm (Comparative Example 2), and the resistance welding was carried out 50 times in each case to calculate the incidence of defectives. Here, the direction of the displacement was the parallel direction to the rolling axis of the flat rolled electrode assembly 11 (the horizontal direction in FIG. 2A). Furthermore, between the dotted lines in FIG. 2A is an expected current passage. As for the determination of the defectives, the resistance value between the negative electrode substrate exposed portions and negative electrode collector was measured to determine the defective having the resistance value not less than a certain value. The concluded results are shown in Table 1.

TABLE 1

| | Comparative | | | Comparative |
|---|---|---|---|---|
| | Example 1 | Example 1 | Example 2 | Example 2 |
| Displacement of | 0 mm | 1.0 mm | 1.5 mm | 2.0 mm |
| Central Axes L | | | | |
| L/W | 0 | 1/3 | 1/2 | 2/3 |
| Incidence of | 30% | 0% | 0% | 70% |
| Defectives | | | | |

W = 3.0 mm

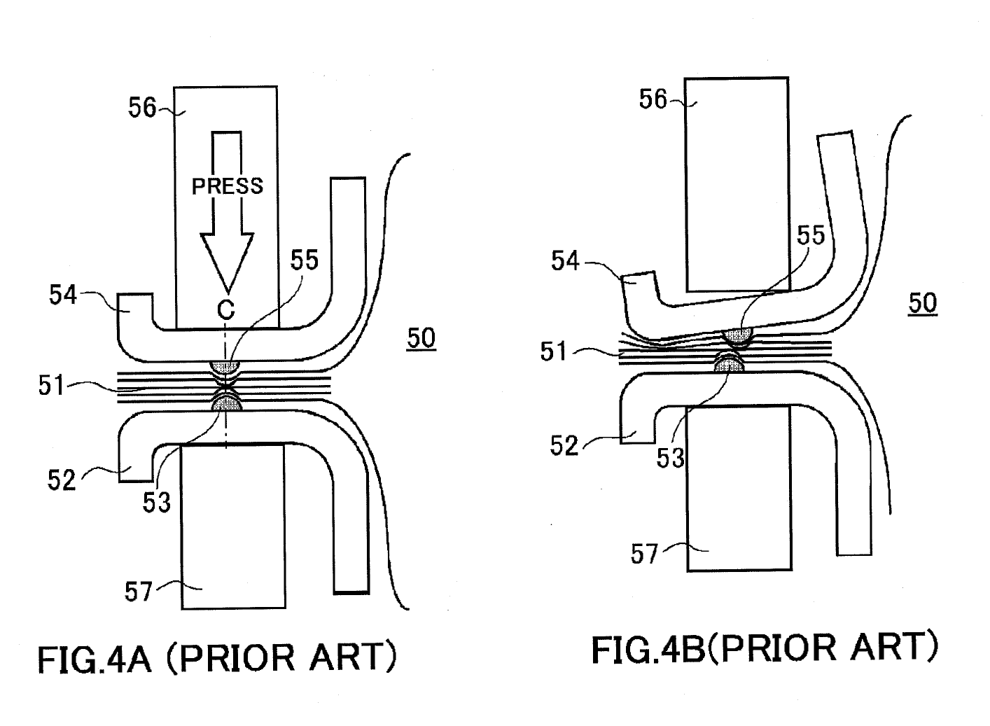

From the results shown in Table 1, the followings are found. In the case of Comparative Example 1 in which the displacement between the central axis of the protrusion 18a of the negative electrode collector 18 and the central axis of the protrusion 25a of the negative electrode collector receiving part 25 L=0 mm, the incidence of defectives was as high as 30%. In contrast, in Example 1 in which the displacement L=1.0 mm, and in Example 2 in which the displacement L=1.5 mm, each incidence of defectives was 0%, that is, the obtained products were all non-defectives. If the central axis of the protrusion 18a of the negative electrode collector 18 exactly corresponds to the central axis of the protrusion 25a of the negative electrode collector receiving part 25, by rights, the resistance welding needs to be best carried out. The results shown in Table 1 are assumed to be caused by that, because the placement of the negative electrode collector 18, collector receiving part 25 and electrode rods 26 and 27 of resistance welding equipment was optimized to have no displacement described above, when the central axis of the protrusion 18a of the negative electrode collector 18 and the central axis of the protrusion 25a of the negative electrode collector receiving part 25 has even a slight displacement due to the error of a manufacturing equipment, at least one of the negative electrode collector 18 and collector receiving part 25 may tilt at an angle as shown in FIG. 4B.

Thus, when the placement of the negative electrode collector 18, collector receiving part 25 and electrode rods 26 and 27 of resistance welding equipment is optimized to have the displacement L (L>0 mm), the negative electrode collector 18 and collector receiving part 25 do not tilt, and whereby the tolerably good resistance welding can be carried out. In this case, it is clear that the lower limit of L with respect to the base diameter of the protrusion W (=3.0 mm) is preferably about W/10≦L from the interpolation value of Comparative Example 1 and Example 1, and more preferably W/3≦L corresponding to that in Example 1. Here, as shown in Comparative Example 2, when the displacement L became larger as 2 mm, the incidence of defectives became 70% larger than that in Comparative Example 1. At this time, the ratio of the displacement L with respect to the base diameter W of the protrusion 18a was 2W/3. Accordingly, it is ascertained that the preferred upper limit of the ratio of the displacement L with respect to the base diameter W of the protrusion 18a is L≦W/2 corresponding to that in Example 2. In summary, it is clear that the displacement L between the respective central axes of hemispherical protrusions of the collector and collector receiving part is preferably W/10≦L≦W/2 with respect to the base diameter W of the protrusion, and more preferably W/3≦L≦W/2.

Here, FIG. 2B shows the schematic sectional view in which the resistance welded part of the prismatic nonaqueous electrolyte secondary battery 10 as the sealed battery obtained in Example 1 was cut parallel to the displacement direction. As shown in FIG. 2B, in the prismatic nonaqueous electrolyte secondary battery 10 as the sealed battery according to an embodiment of the invention, the central axis of the protrusion 18a of the negative electrode collector 18 and the central axis of the protrusion 25a of the negative electrode collector receiving part 25 were resistance-welded in the displacement condition, and consequently, the protrusion 18a of the negative electrode collector 18 and the protrusion 25a of the negative electrode collector receiving part 25 disappeared and a resistance weld mark 28 was formed at this time so as to extend at the angle of the displacement direction. In contrast, in the non-defectives obtained by the resistance welding with a displacement of 0 mm, the resistance weld mark was formed to extend perpendicularly with respect to the negative electrode collector 18 and negative electrode collector receiving part 25. Thus, the sealed battery according to an embodiment of the invention and the sealed battery of the related art example can be distinguished by the cross section shapes of the resistance weld marks.

### Example 3

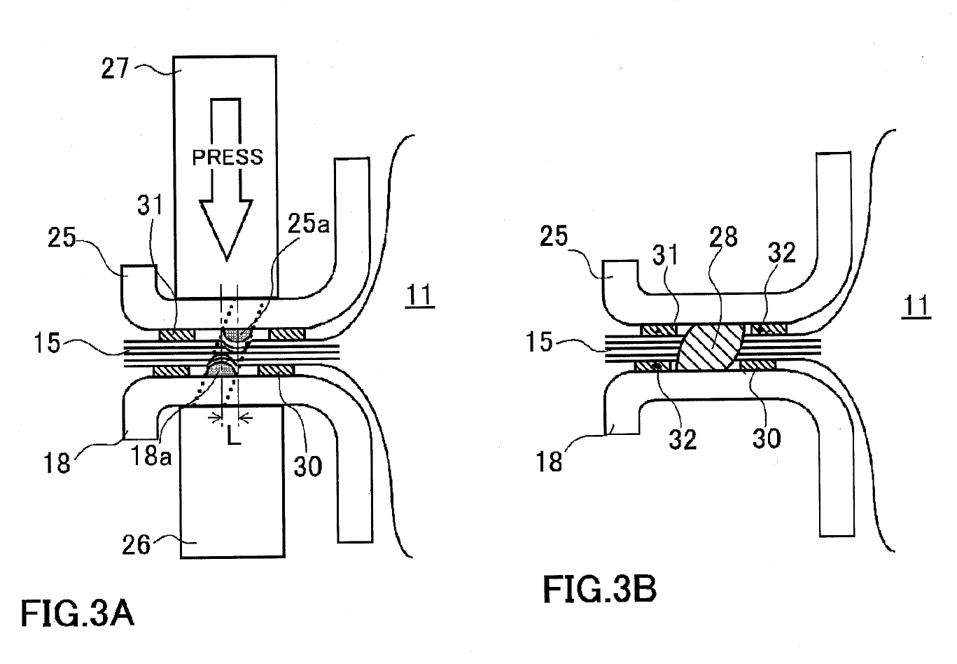

In both Examples 1 and 2, the battery including the electrode collector 18 having only the protrusion 18a and the collector receiving part 25 having only the protrusion 25a was exemplified. However, because the resistance welding current is as very high as a peak current of about 15 kA, spattering is generated during resistance welding, and the spattered particles generated at this time may be dispersed to the exterior. Thus, the method for manufacturing a sealed battery in Example 3 employs the means for inhibiting to disperse such spattered particles from a welding position to the exterior. The method for manufacturing the prismatic nonaqueous electrolyte secondary battery 10 as the sealed battery of Example 3 will be described with reference to FIG. 3.

The prismatic nonaqueous electrolyte secondary battery 10 of Example 3 used the negative electrode collector 18 and negative electrode collector receiving part 25 similar to those used in Example 1, and as shown in FIG. 3A, a tape made of hot-melt adhesive resin 30 was circularly placed around the protrusion 18a of the negative electrode collector 18 and a tape made of hot-melt adhesive resin 31 was circularly placed around the protrusion 25a of the collector receiving part 25. Then, the negative electrode substrate exposed portions 15 made of copper were gathered, then the negative electrode collector 18 made of copper was placed beneath the exposed portions so as to face the top of the protrusion 18a, and likewise, the negative electrode collector receiving part 25 was placed on the upper side of the exposed portions so as to face the top of the protrusion 25a. Then, the displacement L between the central axis of the protrusion 18a of the negative electrode collector 18 and the central axis of the protrusion 25a of the negative electrode collector receiving part 25 was made to be 1 mm. Here, the direction of the displacement was the parallel direction to the rolling axis of the flat rolled electrode assembly 11 (the horizontal direction in FIG. 3A).

In this condition, the copper electrode rods 26 and 27 of resistance welding equipment (not shown in the drawings) were brought into contact with the negative electrode collector 18 and negative electrode collector receiving part 25 from above and below so as to interpose, both of the electrode rods 26 and 27 were pressed against each other to be slightly short-circuited, and then an experimentally determined optimum welding current (a peak current of 15 kA) was applied between both of the electrode rods 26 and 27 for a short period to carry out the resistance welding.

In the prismatic nonaqueous electrolyte secondary battery 10 as the sealed battery obtained in Example 3, no defective on the resistance welded part was observed. Furthermore, FIG. 3B shows the schematic sectional view in which the resistance welded part after such resistance welding was cut parallel to the displacement direction. As shown in FIG. 3B, it was revealed that the resistance weld mark of the prismatic nonaqueous electrolyte secondary battery 10 as the sealed battery manufactured in Example 3 was formed to extend at the angle of the displacement direction described above, and further revealed that the tapes made of hot-melt adhesive resin 30 and 31 were melted by the heat during resistance welding and then solidified, and that spattered particles 32 were caught in the tapes.

In this manner, when the tape made of hot-melt adhesive resin 30 is circularly placed around the protrusion 18a of the negative electrode collector 18 and the tape made of hot-melt adhesive resin 31 is circularly placed around the protrusion 25a of the collector receiving part 25, the spattered particles 32 generated during resistance welding cannot be dispersed to the exterior, and consequently, the effect of inhibiting inner short circuit of the flat rolled electrode assembly 11 due to the spattered particles 32 is provided.

Here, the tapes made of hot-melt adhesive resin 30 and 31 to be used are properly selected from tapes in which the hot-melt adhesive resin has an adhesive temperature of about 70 to 150° C. and a melting temperature of 200° C. or higher, and furthermore, the tapes desirably have the chemical resistance against an nonaqueous electrolyte and the like. Examples of the hot-melt adhesive resin to be used include a rubber seal material, acid modified polypropylene and polyolefin hot-melt adhesive resin.

In Example 3, the battery using the tapes made of hot-melt adhesive resin 30 and 31 was exemplified, but an insulating tape with glue may also be used. Examples of such insulating tape with glue include a polyimide tape, polypropylene tape and polyphenylene sulfide tape. Furthermore, the tape may have a multi-layered structure for a predetermined thickness.

In each of Examples 1 to 3, the battery using the negative electrode substrate, negative electrode collector and negative electrode collector receiving part made of copper was exemplified, but even when these are made of copper alloy, and further even when the positive electrode substrate, positive electrode collector and positive electrode collector receiving part are made of aluminum or aluminum alloy, the invention can be similarly applied. Furthermore, in each of Examples 1 to 3, the rolled electrode assembly was exemplified, but the invention can be similarly applied to a laminated electrode assembly in which a plurality of positive and negative electrode plates were laminated with separators interposed therebetween.

What is claimed is:

1. A method for manufacturing a sealed battery comprising:
(1) forming an electrode assembly for a sealed battery including a plurality of positive electrode substrate exposed portions at one end and a plurality of negative electrode substrate exposed portions at the other end;
(2) bringing into contact a collector and a collector receiving part each having a hemispherical protrusion with both sides of at least one of the plurality of positive electrode substrate exposed portions and the plurality of negative electrode substrate exposed portions, the collector and collector receiving part opposing each other, and when a displacement between central axes of more than one such hemispherical protrusions is L and when a base diameter of the hemispherical protrusion is W, a relation of 0<L≦W/2 being satisfied; and
(3) resistance-welding between the collector and the collector receiving part by applying current under a pressure.

2. The method for manufacturing a sealed battery according to claim 1, wherein, in (2), a circular tape made of hot-melt adhesive resin or a circular insulating tape with glue is placed around each of the hemispherical protrusions.

3. The method for manufacturing a sealed battery according to claim 1, wherein the plurality of substrates, the collector and the collector receiving part are made of copper, copper alloy, aluminum or aluminum alloy.

4. The method for manufacturing a sealed battery according to claim 2, wherein the plurality of substrates, the collector and the collector receiving part are made of copper, copper alloy, aluminum or aluminum alloy.

5. A sealed battery comprising:
an electrode assembly including a plurality of positive electrode substrates exposed at one end and a plurality of negative electrode substrates exposed at the other end; and
a collector and a collector receiving part resistance-welded to at least one of the plurality of substrates interposed therebetween; a resistance weld mark being formed at an angle in the plurality of substrates between the collector and the collector receiving part.

6. The sealed battery according to claim 5, wherein a tape made of hot-melt adhesive resin or an insulating tape with glue is placed around each resistance-welded part between the substrates and the collector and between the substrates and the collector receiving part.

7. The sealed battery according to claim 5, wherein the plurality of substrates, the collector and the collector receiving part are made of copper, copper alloy, aluminum or aluminum alloy.

8. The sealed battery according to claim 6, wherein the plurality of substrates, the collector and the collector receiving part are made of copper, copper alloy, aluminum or aluminum alloy.
